(19) United States
(12) Patent Application Publication
(10) Pub. No.: US 2005/0122407 A1
(43) Pub. Date: Jun. 9, 2005

(54) Image-taking apparatus, image-taking system and control method of image-taking apparatus

(75) Inventor: Hisashi Kawai, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/002,904

(22) Filed: Dec. 3, 2004

(30) Foreign Application Priority Data
Dec. 9, 2003 (JP) 410943/2003 (PAT.

(51) Int. Cl. H04N 5/228

(52) U.S. Cl. 348/222.1

(57) ABSTRACT

An image-taking apparatus is provided with an image-pickup device, a control circuit and a detection circuit. The image-pickup device includes a plurality of pixels and the control circuit controls the driving of the image-pickup device. The detection circuit detects the movement of an object in an image-taking area based on an image signal generated using the image-pickup device. The control circuit controls the driving of the image-pickup device so as to take an image with a first number of pixels when the detection circuit does not detect any movement of the object and take an image with a second number of pixels which is larger than the first number of pixels when some movement of the object is detected.

This application claims priority from Japanese Patent Application No. 2003-410943 filed on Dec. 9, 2003, which is hereby incorporated by reference herein.

### BACKGROUND OF THE INVENTION

1. Field of the Invention

The present invention relates to an image-taking apparatus, and more particularly, to an image-taking apparatus provided with a detection circuit which detects movement of an object and an image-taking system having the image-taking apparatus and control method of the image-taking apparatus.

2. Description of the Related Art

As a conventional monitoring camera system, a technology which changes a compression ratio of communication information generated based on an image taken when abnormality is detected is disclosed (e.g., see Japanese Patent Application Laid-Open No. 2002-245571).

However, since an image-pickup device has low resolution comparable to a video level, it is neither possible to obtain an image with high resolution nor possible to decide the object to be monitored correctly.

Furthermore, a method of moving a monitoring camera to a monitoring target by driving a pan head which is a driving apparatus of the monitoring camera, etc., and zooming in on the object to take close-ups, etc., is proposed.

However, this method identifies a target object, drives a pan head to the target object first, and then zooms in on the target object using a zoom lens, etc., and carries out an image-taking operation, and therefore this method takes time until image-taking is started, which may miss the right moment for image-taking of the target object.

Therefore, it is an object of the present invention to provide an image-taking apparatus, an image-taking system and a control method of the image-taking apparatus capable of immediately taking a detailed image when a problem occurs and taking the whole image.

### SUMMARY OF THE INVENTION

One aspect of the image-taking apparatus of the present invention includes an image-pickup device which has a plurality of pixels, a control circuit which controls the driving of the image-pickup device and a detection circuit which detects movement of an object in an image-taking area based on an image signal generated using the image-pickup device. The control circuit controls the driving of the image-pickup device so as to take an image using a first number of pixels when the detection circuit does not detect any movement of the object and take an image using a second number of pixels which is greater than the first number of pixels when some movement of the object is detected.

The features of the image-taking apparatus of the invention will become more apparent from the following detailed description of a preferred embodiment of the invention with reference to the drawings.

### BRIEF DESCRIPTION OF THE DRAWINGS

FIG. 1 is a functional block diagram of an image-taking system; and

FIG. 2 is a functional block diagram of a monitoring camera and an image processing apparatus.

FIG. 3 is a flow chart which shows the control method of a monitoring camera apparatus.

### DETAILED DESCRIPTION OF THE PREFERRED EMBODIMENTS

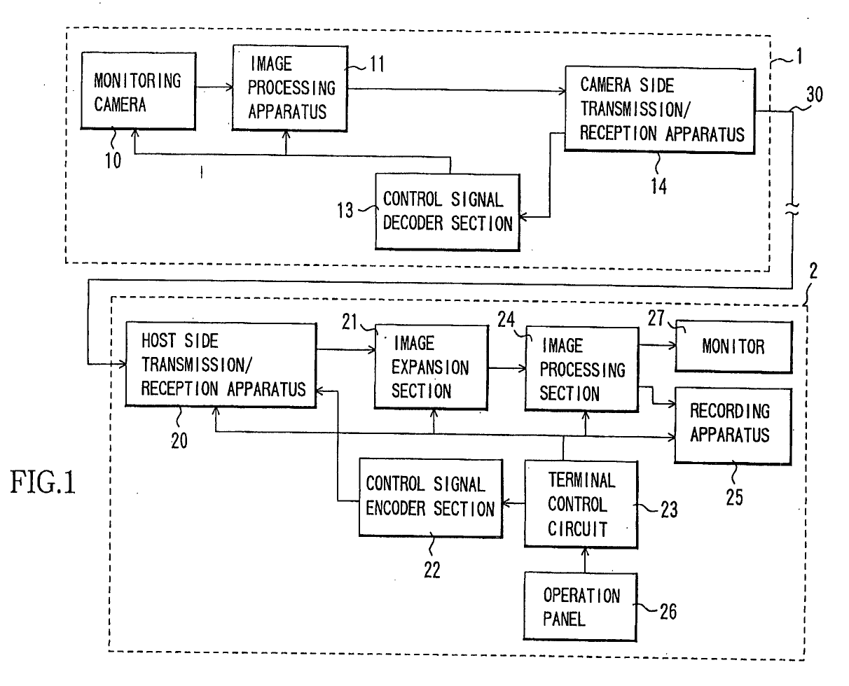

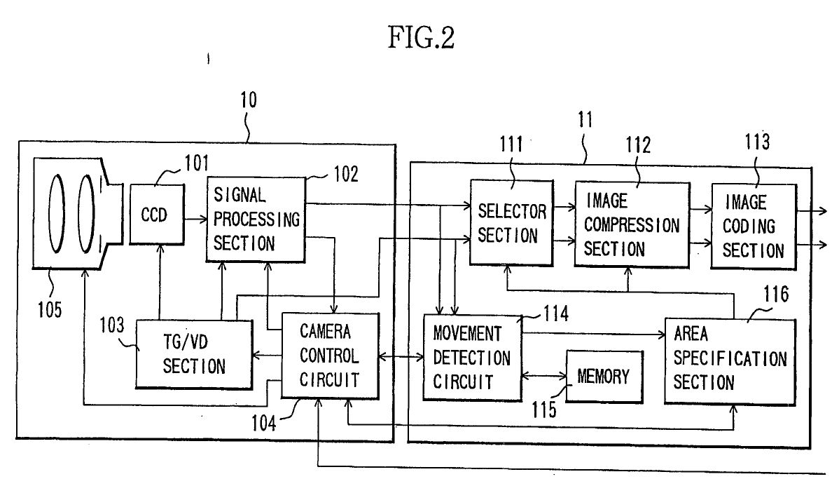

With reference now to FIG. 1 and FIG. 2, an image-taking system which is an embodiment of the present invention will be explained. Here, FIG. 1 is a block diagram of an image-taking system of this embodiment and FIG. 2 is a functional block diagram of a monitoring camera.

In these figures, reference numeral 10 denotes a monitoring camera, which performs an image-taking operation based on an output signal from a camera control circuit 104 which will be described later. Reference numeral 11 denotes an image processing apparatus which processes an image-taking signal output from the monitoring camera 10, details of which will be described later.

Reference numeral 13 denotes a control signal decoder section which demodulates a control signal sent from a monitoring terminal apparatus 2 which will be described later, and reference numeral 14 denotes a camera-side transmission/reception apparatus which is an I/F which communicates with a monitoring terminal apparatus which will be described later.

A monitoring camera apparatus 1 (image-taking apparatus) is constructed of these monitoring camera 10, image processing apparatus 11, control signal decoder section 13 and camera-side transmission/reception apparatus 14.

Reference numeral 20 denotes a host-side transmisslon/reception apparatus which communicates with the camera-side transmission/reception apparatus 14, 21 denotes an image expansion section which expands a compressed image signal sent from the monitoring camera apparatus 1, and 22 denotes a control signal encoder section which sends a control signal which controls the monitoring camera apparatus 1 to the host-side transmission/reception section 20.

Reference numeral 23 denotes a terminal control circuit which controls the entire monitoring terminal apparatus 2, 24 denotes an image processing section which converts the image signal expanded by the image expansion section 21 to a displayable signal and 25 denotes a recording apparatus which records a video signal output from the image processing section 24.

Reference numeral 26 denotes an operation panel which operates the terminal control circuit 23 from the outside, 27 denotes a monitor which displays the image signal converted by the image processing section 24 as an image-taking image, and 30 denotes a network line which connects the monitoring camera apparatus 1 and monitoring terminal apparatus 2.

The monitoring terminal apparatus 2 is constructed of the host-side transmission/reception apparatus 20, image expansion section 21, control signal encoder section 22, terminal control circuit 23, image processing section 24, recording apparatus 25, operation panel 26 and monitor 27.

Next, details of the structure of the monitoring camera 10 will be explained.

Reference numeral 101 denotes an image-pickup device which converts an optical signal condensed by a lens unit which will be described later to an electric signal. This embodiment uses a CCD as the image-pickup device, but a CMOS image sensor, for example, may also be used.

Reference numeral 102 denotes a CCD signal processing section which converts an image-taking signal photoelectrically converted by the CCD 101 to an image signal, and 103 denotes a TG/VD as a timing generator/vertical driver which drives the CCD 101. Reference numeral 104 denotes a camera control circuit (control means) which controls the entire monitoring camera 10, and 105 denotes a lens unit which condenses reflected light from the object onto the image-taking surface of the CCD 101.

Next, the structure of the image processing apparatus 11 will be explained.

Reference numeral 111 denotes a selector section which selects and outputs an image area, and 112 denotes an image compression section which compresses an image signal output from the selector section 111.

Reference numeral 113 denotes an image coding section which converts the image signal compressed by the image compression section 112 to a signal suitable for communication, 114 denotes a movement detection circuit which causes a memory 115 to store the image signal from the signal processing section 102, calculates a difference between the image signal read from this memory 115 and a newly input image signal to detect the movement of the object.

Reference numeral 115 denotes a memory which stores the image signal outputted from the movement detection circuit 114, and 116 denotes an area specification section which specifies an area of the image signal compressed based on the signal from the movement detection circuit 114.

In this embodiment, the monitoring camera 10 is separated from the image processing apparatus 11, but the monitoring camera 10 may also be constructed of the CCD 101, camera control circuit 104 and image processing apparatus 11.

Next, the operation of the image-taking system will be explained with reference to FIG. 1. The image-taking system of the present embodiment is constructed so as to be able to switch between a normal monitoring mode (mode 1) and abnormality monitoring mode (mode 2) and changes the number of pixels read from the CCD 101 according to each mode.

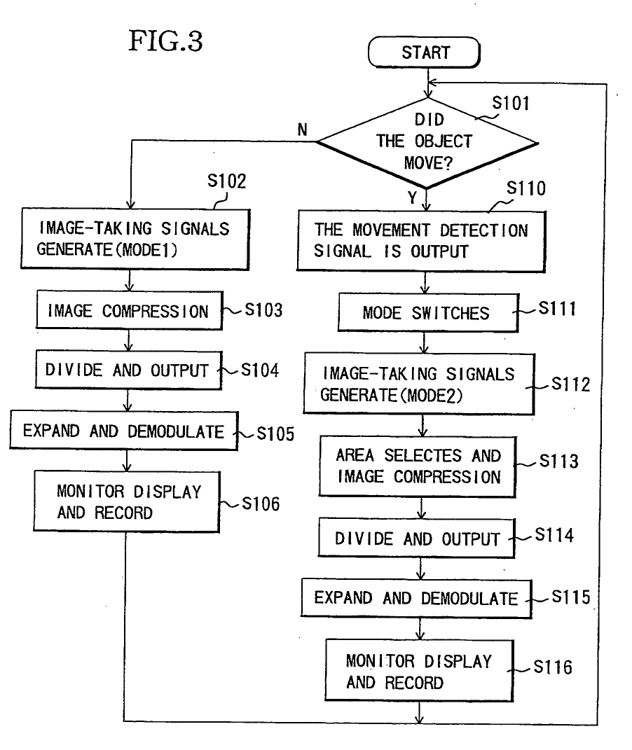

With reference to FIG. 3, the operation of the image-taking system in a normal monitoring mode and an abnormality monitoring mode will be explained. Control of the monitoring camera apparatus is performed by the camera control circuit 104, control of the monitoring terminal apparatus is performed by the terminal control circuit 23. First, the operation of the image-taking system in a normal monitoring mode will be explained.

The signal photoelectrically converted by the CCD 101 is converted to a video signal by the signal processing section 102. Here, in the normal monitoring mode, the CCD 101 is driven in a high-speed draft mode and in this high-speed draft mode, image-taking pixels are selected from among the image-taking pixels of the CCD 101 by the TG of the TG/VD 103 at predetermined intervals in the vertical direction and a video signal is generated based on color signals (R, G/B, G) output from the selected image-taking pixels (S102).

With regard to the video signal generated by the signal processing section 102, pixels in the horizontal direction are selected by the selector section 111, while the area is not selected and sent to the image compression section 112. That is, the image-taking pixels of the CCD 101 in the vertical direction are selected during a CCD read, while image-taking pixels in the horizontal direction are selected by the selection section 111 after the video signal is sent to the image processing apparatus 11.

The image compression section 112 attaches the monitoring image information in a normal mode whose area is not specified to the start of the compressed image and compresses the image (S103), and then the image coding section 113 divides the compressed information into blocks of a predetermined amount of information and outputs the information to the camera-side transmission/reception apparatus 14 (S104).

The block-divided compressed information is sent from the camera-side transmission/reception apparatus 14 to the host-side transmission/reception apparatus 20 through a network line 30 and reunited as one piece of compressed image information. The reunited compressed image information is sent to the image expansion section 21, expanded and demodulated into a displayable video signal (S105).

The demodulated video signal is sent to and displayed on the monitor 27 and recorded in the recording apparatus 25 (S106).

Next, the operation of the image-taking system in an abnormality monitoring mode will be explained.

When the movement detection circuit 114 detects some movement of the object based on the difference between the image information recorded in the memory 115 and newly input image information (S101), a detection signal is output from the movement detection circuit 114 to the camera control circuit 104 (S110).

The camera control circuit 104 switches the drive mode of the TG/VD 103 from the normal monitoring mode to the abnormality monitoring mode based on the detection signal output from the movement detection circuit 114 (S111). When the drive mode is changed to the abnormality monitoring mode, the image-taking mode is set to a so-called full pixel read mode and all image-taking signals from the CCD 101 are read and output to the signal processing section 102 (S112).

The color array of pixels read in the abnormality monitoring mode is the same as the read array in the normal monitoring mode, and the processing at the signal processing section 102 is carried out in the same way as in the normal monitoring mode.

The video signal output from the signal processing section 102 is input to the selector section 111. The selector section 111 selects the area of the signal based on the signal from the area specification section 116 and outputs the signal to the image compression section 112 (S113).

Here, a method of determining an area to be specified will be explained. The location of the movement detected within the image-taking area by the movement detection circuit 114 is specified based on a synchronization signal from the TG and the vertical line number and horizontal pixel number are output to the camera control circuit 104.

The camera control circuit 104 outputs the vertical line number and horizontal pixel number of the pixel at top left of the area selected by the selector section 111 to the area specification section 116 based on the position information sent from the movement detection circuit 114.

The area specification section 116 selects an image signal outputted to the image compression section 112 from the selector section 111 based on the position information from the camera control circuit 104, the vertical synchronization signal, horizontal synchronization signal and clock signal from the TG.

The image compression section 112 attaches image start end information (vertical line number and horizontal pixel number of the pixel at top left of the area) to the start of the image information and creates compressed information (S113). The subsequent processing is the same as that in the normal monitoring mode (S114).

The monitoring terminal apparatus 2 expands the image information compressed by the image expansion section 21 (S115), the start end information attached to the start of the compressed image information is converted to a video signal by the image processing section 24 and an expanded image thereof is displayed on the monitor 27 (S116).

Furthermore, when some movement is detected at a plurality of positions in the image-taking area, start end information of each image is generated according to the detection target and attached to the compressed information.

Furthermore, it is also possible to combine and output a high definition image in the abnormality monitoring mode not to a normal monitor but to a high definition monitor.

While preferred embodiments have been described, it is to be understood that modification and variation of the present invention may be made without departing from the scope of the following claims.

1. An image-taking apparatus comprising:
an image-pickup device which has a plurality of pixels;
a control circuit which controls the driving of the image-pickup device; and
a detection circuit which detects some movement of an object in an image-taking area based on an image signal generated using the image-pickup device,
wherein the control circuit controls the driving of the image-pickup device so as to take an image with a first number of pixels when the detection circuit does not detect any movement of the object and take an image with a second number of pixels which is larger than the first number of pixels when some movement of the object is detected.

2. The image-taking apparatus according to claim 1, wherein the second image-taking area in which an image is taken with the second number of pixels is narrower than the first image-taking area in which an image is taken with the first number of pixels.

3. The image-taking apparatus according to claim 2, further comprising an area selection circuit which selects the second image-taking area based on information of the movement of the object obtained by the detection circuit.

4. The image-taking apparatus according to any one of claims 1 to 3, further comprising a transmission circuit which transits image information obtained from the image-pickup device to a network.

5. An image-taking system comprising:
the image-taking apparatus according to claim 4; and
a reception apparatus which receives image information transmitted from the image-taking apparatus through the network.

6. A control method of an image-taking apparatus which includes an image-pickup device having a plurality of pixels comprising:
a detection step in which detects some movement of an object in an image-taking area based on an image signal generated using image-pickup device,
a control step in which controls the driving of the image-pickup device so as to take an image with a first number of pixels when the detection circuit does not detect any movement of the object and take an image with a second number of pixels which is larger than the first number of pixels when some movement of the object is detected.
